(19) United States
(12) Patent Application Publication
(10) Pub. No.: US 2022/0374323 A1
(43) Pub. Date: Nov. 24, 2022

(54) METHOD AND APPARATUS FOR TUNING A DEVICE

(71) Applicant: OMRON Corporation, Kyoto-shi (JP)

(72) Inventors: Atul Govande, Simi Valley, CA (US); Andrew Chen, Huntington Beach, CA (US); Xuanvu Cu, Canoga Park, CA (US); Sina Sattari, Porter Ranch, CA (US)

(21) Appl. No.: 17/664,390

(22) Filed: May 20, 2022

Related U.S. Application Data
(60) Provisional application No. 63/191,882, filed on May 21, 2021.

(51) Int. Cl. G06F 11/27; G06F 9/451

(52) U.S. Cl. CPC G06F 11/27; G06F 9/451

(57) ABSTRACT

A tuning system for live tuning of a motor is disclosed. The tuning system can implement a tuning process that periodically provides tuning parameters and tests to a device for tuning in response to initiation of a tuning process such that parameters can be adjusted during the tuning process. The tuning system can include tuning tool(s) and associated application(s) configured to run thereon. The associated application(s) can include a tuning application, a middleware application to gather data relating to the tuning, a networking program to stream tuning results to a computing device. The computing device can include a networking program to receive the tuning results that are streamed from the tuning system through its networking program and a user interface (UI) application to display the tuning results.

### CROSS-REFERENCE TO RELATED APPLICATION(S)

This application claims the benefit of U.S. Provisional Application No. 63/191,882, filed May 21, 2021, which is hereby incorporated by reference in its entirety.

### TECHNICAL FIELD

This disclosure generally relates to the tuning of devices, such as the tuning of motors used in robotic systems.

### BACKGROUND

Devices (e.g., motors) are used to perform and/or automate tasks. Devices can include a number of electronics that enable the mobile robots to perform tasks. To enable a particular operation of the devices, the devices may be tuned. In one example, a device can connect to a computing device for tuning. The device can be tuned and then perform the particular operation.

### SUMMARY

One aspect of the present disclosure is a system for live tuning of a motor. The system can include a first system and a second system. The first system can include a tuning tool and associated applications configured to run thereon. The associated applications can include a tuning application, a middleware application to gather data relating to the tuning, a networking program to stream data to the second system. The second system can include a networking program to receive the data that is streamed from the first system through its networking program. The second system can also include a user interface (UI) application to display the received data in a numerical or graphical format for example, and to enable a user to start or stop a tuning process and adjust settings or parameters associated with the tuning. Furthermore, the second system can include a program to allow the networking program to run on a device of the second system, for example, if the networking program is designed for an operating system (OS) that is different from the OS that is running on the device of the second system.

In another aspect of the present disclosure, a method for live tuning of a motor is disclosed. The method may involve receiving data indicative of a request to start a tuning process of a motor, creating a data connection between a first system and a second system, wherein the first system is associated with a tuning tool, and the second system is associated with a UI for displaying and receiving data. The method may further involve receiving, at the first system and from the second system, data related to one or more settings or parameters related to the tuning process; executing a tuning move based on the one or more settings or parameters; and transmitting, from the first system to the second system, data related to a result of the tuning move.

In another aspect of the present disclosure, an apparatus configured to execute the method of live tuning of a motor is disclosed. The apparatus can include a processor and a storage device configured to store one or more instructions thereon, wherein the one or more instructions, when run by the processor, are configured to execute the method of the method of live tuning of a motor.

One aspect of the present disclosure is a system for tuning a device. The system can include a user interface, at least one processor, and a memory storing computer-executable instructions for execution by the at least one processor. The at least one processor can obtain one or more first parameters. Further, the at least one processor can identify a first test. The at least one processor can initiate a tuning process of the device based on the first test and the one or more first parameters. In response to initiating the tuning process, the at least one processor can provide the first test and the one or more first parameters to the device, obtain, from the device, tuning results based on providing the first test and the one or more first parameters to the device, cause display of at least a portion of the tuning results via a display of the user interface, and automatically provide a second test and/or one or more second parameters to the device subsequent to providing the first test and the one or more first parameters to the device.

In another aspect of the present disclosure, the at least one processor can obtain additional tuning results based on providing the second test and/or the one or more second parameters to the device. Further, the at least one processor can cause display of at least a portion of the additional tuning results via the display of the user interface.

In another aspect of the present disclosure, the one or more second parameters include the one or more first parameters.

In another aspect of the present disclosure, the one or more second parameters and the one or more first parameters are different parameters.

In another aspect of the present disclosure, the first test and the second test are different tests.

In another aspect of the present disclosure, the second test and the first test are a same test.

In another aspect of the present disclosure, the first test includes at least one of a step test, a ramp test, a parabolic velocity test, a trapezoidal velocity test, an s-curve velocity test, a sinusoidal test, a sinesweep test, or a user-defined test.

In another aspect of the present disclosure, the first test includes a move size, a move speed, and a move profile.

In another aspect of the present disclosure, the one or more first parameters include at least one of a proportional gain, a derivative gain, a velocity feedforward gain, an integral gain, an acceleration feedforward gain, or a friction feedforward gain.

In another aspect of the present disclosure, the one or more first parameters include one or more hardware parameters. The one or more hardware parameters may be based on at least one of one or more hardware components of the device, a connection between the device and the system, or a connection between the device and a component.

In another aspect of the present disclosure, the at least one processor can automatically provide the second test and/or the one or more second parameters to the device without reinitiating the tuning process.

In another aspect of the present disclosure, the at least one processor can obtain the one or more first parameters via the user interface.

In another aspect of the present disclosure, the at least one processor can receive user input via the user interface. Further, the at least one processor can initiate the tuning process based on the user input.

In another aspect of the present disclosure, the at least one processor can automatically provide the second test and/or the one or more second parameters without receiving user input via the user interface.

In another aspect of the present disclosure, the at least one processor can obtain the tuning results via a data stream from the device.

In another aspect of the present disclosure, the at least one processor can determine that user input defining the second test and/or the one or more second parameters has not been obtained prior to automatically providing the second test and/or the one or more second parameters to the device. Further, the at least one processor can reprovide the first test and the one or more first parameters to the device based on determining that user input has not been obtained prior to automatically providing the second test and/or the one or more second parameters to the device.

In another aspect of the present disclosure, the at least one processor can determine that user input has been obtained prior to automatically providing the second test and/or the one or more second parameters to the device. Further, the user input can identify at least one of the second test or the one or more second parameters. The at least one processor can automatically provide the second test and/or the one or more second parameters to the device based on determining that user input has been obtained prior to automatically providing the second test and/or the one or more second parameters to the device. The at least one of the first test and the second test may be different tests or the one or more first parameters and the one or more second parameters may include different parameters.

In another aspect of the present disclosure, the at least one processor can determine that user input has not been obtained prior to automatically providing the second test and/or the one or more second parameters to the device. The at least one processor can provide the first test and the one or more first parameters to the device based on determining that user input has not been obtained prior to automatically providing the second test and/or the one or more second parameters to the device. The one or more second parameters may include the one or more first parameters and the second test and the first test may be a same test. The at least one processor can obtain additional tuning results based on providing the second test and/or the one or more second parameters to the device. Further, the at least one processor can cause display of at least a portion of the additional tuning results via the display of the user interface. The at least one processor can identify one or more third parameters and a third test. Further, the at least one processor can provide the third test and the one or more third parameters to the device based on identifying the one or more third parameters and the third test. At least one of the first test and the third test may be different tests or the one or more first parameters and the one or more third parameters may include different parameters.

In another aspect of the present disclosure, the one or more first parameters and the first test may be provided to the device during a first tuning interval of a tuning schedule and the second test and/or the one or more second parameters may be provided during a second tuning interval of the tuning schedule. Further, the at least one processor can obtain one or more third parameters subsequent to the first tuning interval and prior to the second tuning interval and store the one or more third parameters. The at least one processor can obtain the one or more second parameters after obtaining the one or more third parameters subsequent to the first tuning interval and prior to the second tuning interval and replace the one or more third parameters with the one or more second parameters. Further, the at least one processor can automatically provide the second test and/or the one or more second parameters to the device based on replacing the one or more third parameters with the one or more second parameters. Further, the one or more third parameters may not be utilized to tune the device.

In another aspect of the present disclosure, the device is a servo motor.

In another aspect of the present disclosure, the at least one processor can obtain the one or more second parameters from memory.

In another aspect of the present disclosure, the at least one processor can store the one or more first parameters in memory. Further, the at least one processor can obtain the one or more second parameters. The at least one processor can replace the one or more first parameters with the one or more second parameters in the memory based on obtaining the one or more second parameters.

In another aspect of the present disclosure, the at least one processor can cause display of the one or more first parameters, data associated with the first test (e.g., a type of test), and/or the at least a portion of the tuning results.

In another aspect of the present disclosure, the at least one processor can, in response to initiating the tuning process, periodically provide a corresponding test and one or more corresponding parameters to the device.

In another aspect of the present disclosure, the at least one processor can determine that the tuning process has been discontinued. Further, the at least one processor can discontinue periodically providing the corresponding test and the one or more corresponding parameters to the device based on determining that the tuning process has been discontinued.

In another aspect of the present disclosure, the at least one processor can obtain user input. Further, the at least one processor can determine that the tuning process has been discontinued based on the user input.

In another aspect of the present disclosure, the at least one processor can determine a tuning schedule. Further, the at least one processor can provide the first test and the one or more first parameters to the device during a first time period based on the tuning schedule. The at least one processor can further automatically provide the second test and/or the one or more second parameters to the device during a second time period based on the tuning schedule.

In another aspect of the present disclosure, the device can generate the tuning results based on the one or more first parameters and the first test.

In another aspect of the present disclosure, a non-transitory computer readable storage medium is disclosed. The non-transitory computer readable medium can have stored thereon instructions that, when executed, can cause at least one computing device to obtain one or more parameters. Further, the computer device can identify a test. The computing device can initiate a tuning process of the device based on the test and the one or more parameters. In response to initiating the tuning process, periodically, the computing device can provide the test and the one or more parameters to the device, obtain, from the device, tuning results based on providing the test and the one or more parameters to the device, and cause display of at least a portion of the tuning results via a display of a user interface.

In another aspect of the present disclosure, a method is disclosed that can include obtaining one or more parameters. The method can further include identifying a test. The method can further include initiating a tuning process of the device based on the test and the one or more parameters. The method can include, in response to initiating the tuning process, periodically, providing the test and the one or more parameters to the device, obtaining, from the device, tuning results based on providing the test and the one or more parameters to the device, and causing display of at least a portion of the tuning results via a display of a user interface.

In another aspect of the present disclosure, a method for tuning a device is disclosed that can include obtaining one or more first parameters. The method can include performing a first test on the device using the one or more first parameters. Further, the method can include outputting test results from the first test. The method can include obtaining one or more second parameters different from the one or more first parameters during performance of the first test. The method can include storing the one or more second parameters while the first test finishes using the one or more first parameters. The method can further include, after completion of the first test, automatically performing a second test on the device using the one or more second parameters. The method can include outputting the results from the second test.

In another aspect of the present disclosure, the method can further include obtaining the one or more second parameters via a user interface.

In another aspect of the present disclosure, the method can further include performing a plurality of tests on the device using the one or more first parameters before obtaining the one or more second parameters.

In another aspect of the present disclosure, the method can further include obtaining one or more interim parameters during performance of the first test and before obtaining the one or more second parameters. The one or more second parameters may replace the one or more interim parameters before the interim parameters are used in testing.

In another aspect of the present disclosure, the method can further include transferring test results data for the first test during performance of the first test.

In another aspect of the present disclosure, the method can further include transferring test results data for the first test using a data stream between the device and a tuning system.

In another aspect of the present disclosure, the method can further include transferring test results data for the first test without saving the test results data to a file.

In another aspect of the present disclosure, the method can further include transferring test results from a first volatile memory on the device to a second volatile memory on a tuning system.

In another aspect of the present disclosure, a system for tuning a device is disclosed. The system can include at least one processor and a memory storing computer-executable instructions. Execution of the computer-executable instructions by the at least one processor may cause the at least one processor to perform the method as discussed above.

In another aspect of the present disclosure, a non-transitory computer readable storage medium is disclosed. The non-transitory computer readable storage medium may have stored thereon instructions that, when executed, may cause at least one computing device to perform the method as discussed above.

The foregoing summary is illustrative only and is not intended to be limiting. Other aspects, features, and advantages of the systems, devices, and methods and/or other subject matter described in this application will become apparent in the teachings set forth below. The summary is provided to introduce a selection of some of the concepts of this disclosure. The summary is not intended to identify key or essential features of any subject matter described herein.

### BRIEF DESCRIPTION OF THE DRAWINGS

Various examples are depicted in the accompanying drawings for illustrative purposes, and should in no way be interpreted as limiting the scope of the examples. Various features of different disclosed examples can be combined to form additional examples, which are part of this disclosure.

FIG. 1 depicts an example environment including a computing device for tuning a device in accordance with aspects of the present disclosure.

FIG. 2 illustrates a workflow related to live tuning of a motor, according to some embodiments of the present disclosure.

FIG. 3 illustrates a user interface (UI) related to live tuning of a motor, according to some embodiments of the present disclosure.

FIG. 4 illustrates a user interface (UI) related to live tuning of a motor, according to some embodiments of the present disclosure.

FIG. 5 is a flowchart of an example routine for tuning a device according to some embodiments.

### DETAILED DESCRIPTION

Generally described, the present disclosure relates to tuning methods and apparatuses for tuning a device (e.g., a motor, a machine, a computing device, an engine, a chip, or any other devices) using a tuning system. For example, the tuning system can tune a stator motor of a mobile robot, an engine of an automobile, a chip in an electronic control unit, etc. By tuning the device, the tuning system can adjust the performance of the device such that the device satisfies or exceeds a performance threshold. The tuning system can adjust the performance of the device by adjusting tuning parameters or settings (e.g., gains) of the device.

The tuning methods and apparatus described herein enable a tuning system to initiate a tuning process to continuously (e.g., automatically and/or periodically) tune a device based on a test (e.g., a tuning move or iteration) and/or tuning parameters (e.g., parameters for execution of the tuning move or iteration) while allowing the tuning system to provide updated or modified test and/or tuning parameters on the fly. The tuning system can initiate the tuning process in response to user input received via a user computing device. As described herein, the user computing device can periodically send a test (e.g., data (instructions or a command) that identifies a tuning move or iteration for execution by the device) and/or tuning parameters (e.g., parameters identifying how the device is to execute the tuning move or iteration) to the motor for tuning the motor without the reinitiation of the tuning process. Further, the user computing device can periodically send the test and/or the tuning parameters without stopping the tuning process to write data to a file and store it in a storage device for further processing or initiating a new tuning process. By automatically and periodically sending the test and/or the tuning parameters to the device without reinitiating a tuning process, the “live” or “interactive” tuning of a device can reduce the tuning time for tuning a device. Therefore, the efficiency and speed of the tuning of the device can be increased by live tuning the device. As used herein, tuning a device may generally include a process of adjusting various types of parameters (e.g., gains) associated with a device in a control loop until a particular performance level or output is achieved by the device (e.g., the performance level of the device satisfies or exceeds a performance threshold value).

In one example, the tuning system can perform the tuning process for live tuning of a motor (e.g., a stator motor). For example, the motor may be a motor utilized in a robotics system, including but not limited to a system with a mobile robot, Selective Compliance Articulated Robot Arm (“SCARA”), etc.

In many conventional cases, implementing a general tuning process to tune a device may not provide satisfactory results in particular circumstances or for particular users. Such a general tuning process (e.g., a repetitive tuning process) may include starting and stopping the tuning process for each iteration or test. For example, the general tuning process may include initiating a tuning process and providing a test and/or parameters to a motor, obtaining tuning results, causing display of tuning results, and initiating an updated tuning process with updated tests and/or parameters based on the tuning results of the first iteration or test. Each modification of the test and/or parameters may be implemented based on reinitiation of the tuning process. For example, a user computing device may provide an updated test and/or parameters and request reinitiation of the tuning process. In some embodiments, to avoid iteratively reinitiating the tuning process with updated tests and/or parameters, the parameters may be predetermined. For example, if the device includes a motor, encoder and drive that are provided as one package from a single vendor, the parameters may be predetermined based on the known settings of the encoder and drive. This may prove unsatisfactory where the predetermined parameters cause a performance of the device that is below a performance threshold. For example, while the device may have predetermined parameters, the predetermined parameters may cause performance below a performance threshold or may cause performance below a performance caused by a different set of a parameters.

Tuning processes for devices (e.g., electromechanical motors) may be time-consuming and tedious, and may involve a “trial-and-error” approach to achieve a performance level of the device that exceeds or satisfies a particular performance threshold. The trial-and-error approach may include implementing multiple iterations of the tuning process, each iteration including an updated test or an updated set of parameters to determine parameters that correspond to a performance exceeding or satisfying a particular performance threshold. Each iteration of the tuning process may include initiating the tuning process and providing an updated set of parameters and/or an updated test (e.g., based on user input received via an input/output device). For example, a user may interact with an input/output device (e.g., a touchscreen, buttons, etc.) of a tuning system to start the tuning process. A user may repeat the iterative process by reinitiating the tuning process until the performance of the device satisfies or exceeds a performance threshold value (e.g., a predetermined performance criteria). Such an iterative and repetitive tuning process may be resource extensive and time consuming.

One example of the traditional trail-and-error approach is a “servo tuning” process for tuning a servo motor. A servo motor as used herein generally refers to an electromechanical device that can produce torque and velocity based on current and voltage that are supplied to the servo motor. The servo tuning process may involve adjusting various parameters in a motion controller associated with a servo motor system for the tuning of the servo motor. The servo tuning process may be time-intensive as numerous iterations of the tuning process may be implemented to identify a set of parameters that cause the performance of the servo motor to exceed or satisfy a performance threshold value. Each iteration of the tuning process may include an intervention for changing settings or parameters, stopping the tuning process, writing the data related to each iteration to a file, storing the data, etc. For example, each iteration of the tuning process may involve obtaining user input (e.g., via an input/output device) to initiate tuning, providing the results of an iteration of the tuning process after the tuning data has been collected and processed (e.g., the results of the tuning iteration may be displayed via a display of a computing device), obtaining updated parameters, and obtaining additional user input to resume the tuning process, and providing results of a new iteration of the tuning process. The traditional trial-and-error approach may include writing relevant data (e.g., test results data) to a file, uploading the file to a server, and enabling the file to be retrieved and processed for generating associated data, and/or rendering/displaying it via a graphical user interface (GUI).

As devices (e.g., motors, engines, computing devices, etc.) proliferate, the demand for faster and more efficient tuning of the devices has increased. The present disclosure provides a tuning system for tuning a device with significant advantages over prior implementations. The present disclosure provide systems and methods that enable a reduction in the time and user interactions, relative to traditional embodiments, to identify a set of parameters for a device such that the performance of the device satisfies or exceeds a performance threshold value without significantly affecting the speed or power consumption of the device when tuning. These advantages are provided by the embodiments discussed herein, and specifically by implementation of a live or interactive tuning process that enables a tuning system to continuously tune the device.

As described herein, the live tuning process of the device may include a continuous tuning process (e.g., a periodic tuning process). During the tuning process, after initialization of the tuning process and provision of initial parameters and/or an initial test, at periodic or aperiodic intervals, the tuning system may automatically (e.g., without reinitialization of the tuning process after initialization of the tuning process and prior to stopping the tuning process) and periodically (e.g., at periodic intervals based on a tuning schedule) provide a test and/or parameters to the device for tuning the device. For example, at each interval, the tuning system may periodically and automatically provide a test and parameters to device and, based on providing the test and parameters to the device, obtain tuning results. The test and parameters provided at each interval may include an updated test and/or updated parameters. In some embodiments, the tuning system may provide the same test and/or parameters (e.g., periodically and automatically provide the same test and/or parameters at each interval of the tuning schedule subsequent to initiation of the tuning process) to the device until an updated test and/or parameters are obtained. Further, the continuous tuning process may be continuously implemented based on the same test and/or parameters until an updated test and/or parameters are provided.

The tuning system may initiate the tuning process based on input. For example, the tuning system may initiate the tuning process based on user input received via a user computing device. A user computing device may initiate the live tuning process and provide a test (e.g., specify a tuning move or iteration for execution by the device) and/or a set of a parameters (e.g., a set of parameters for execution of the tuning move or iteration). The user computing device may provide the test by providing an indication (e.g., a selection) of a particular test or load (e.g., from a user interface). In some cases, the user computing device can obtain user input to initiate the live tuning process via an input/output device. For example, the user computing device can obtain user input to initiate the live tuning process based on input via a display of a computing device, input via a button on a user interface (UI), input via a keyboard, input via a touchscreen, input via one or more buttons or a keypad or any other suitable user input elements, etc.

The tuning system may include one or more tuning tools for tuning the device. Each of the one or more tuning tools may implement a tuning application to perform the live tuning process. A tuning application (e.g., “appware”) may run continuously on a tuning tool of the one or more tuning tools. In one example, a tuning tool may utilize an integrated development environment, such as the Power Programmable Multi-Axis Controller (“PMAC”) Integrated Development Environment (“IDE”) developed by Omron Automation. The tuning system, via the one or more tuning tools and the tuning application, may implement the tuning process and obtaining tuning results.

The tuning system may be in data communication with a computing device to obtain parameters and/or test and provide the tuning results. The computing device may receive the data collected by the tuning tool (e.g., the tuning results). Further, the computing device can cause display of the tuning results (e.g., to the user) via a UI on the computing device (e.g., as a graph, a set of statistical data, etc.).

After initiation of the tuning process and during the implementation of the tuning process (e.g., at any given point in time while the tuning process is ongoing), the user computing device can modify the test and/or the parameters relating to the tuning process (e.g., on the fly). For example, the user computing device can provide an updated test (e.g., a user computing device may provide a selection of an updated type of test or load) and/or updated parameters for implementation in the tuning process. The user computing device can provide the updated test and/or the updated parameters to the tuning system.

The tuning system can obtain, from the user computing device, the updated test and/or the updated parameters in memory (e.g., a cache, a data store, a data base, a data queue, etc.). At each interval of the tuning process, the tuning system can obtain the test and/or the updated parameters from the memory (e.g., which may have been updated since during the previous test) and can provide the updated test and/or the updated parameters to the device for tuning. In some embodiments, the user computing device may not provide an updated test and/or updated parameters and the memory may include the same test and/or the same parameters for multiple intervals. Therefore, the tuning system can obtain the same test and/or the same parameters from the memory and provide the same test and/or the same parameters to the device for tuning at each of the multiple intervals.

In some embodiments, the user computing device may provide multiple tests and/or multiple sets of parameters to the tuning system (e.g., between intervals of the tuning process). The tuning system may replace the test and/or parameters of the memory with an updated test and/or parameters as the updated test such that the tuning system provides the most recently received test and/or parameters to the device at each interval. By way of example, the tuning system can receive an updated value for a parameter while a test is being performed (e.g., using previously received parameters). The tuning system can store the updated value for the parameter, and the current test can continue using the previously received parameters. Once the test is completed, the tuning system can run a new test that uses the updated value for the parameter. In some cases, a second updated value can be received by the tuning system while the test is running with the previously received parameters, and the second updated value can replace the prior updated value for the parameter. The updated value can be overwritten by the second updated value for the parameter. Then, the next test can use the second updated value for the parameter. In this example, the first updated value is not used in the testing, because that value had already been replaced by the second updated value by the time the next test was ready to begin. The tuning device can continuously start the next test using whatever parameters are currently presented (e.g., most recently provided to the tuning device). In other embodiments, the tuning system may store multiple tests and/or multiple sets of parameters in the memory. For example, the tuning system may remove each test and each set of parameters from the memory as it is provided to the device for tuning.

Based on the test and/or the parameters provided by the tuning system at each interval, subsequent to each interval, the tuning system may receive tuning results from the device. The tuning system can receive the tuning results and provide the tuning results to the user computing device for display. Therefore, the user computing device may receive updated tuning results and the displayed tuning results may be modified accordingly on the UI of the user computing device almost immediately. In response to the user tuning results, the user computing device may provide an updated test and/or parameters. For example, the user computing device may periodically provide an updated test and/or parameters such that the performance level of the device satisfies or exceeds a performance threshold value.

In one example, the tuning system may implement a continuous tuning process with any type of motor-encoder-drive combination. For example, the tuning system may implement the continuous tuning process for any motor-encoder-drive combination associated with a particular precision threshold and flexibility in motion control threshold. Such a tuning system that is not dependent on any particular type of device (e.g., a particular motor-encoder-drive combination) can make the traditional tuning process complex, time consuming, and inefficient. For example, because the settings for the device may be unknown, determining a set of parameters that cause the performance of the device to satisfy a performance threshold can be time consuming. However, because the continuous tuning process enables the periodic and automatic tuning of the device such that parameters and a test are provided to the device at each interval of the tuning process, the efficiency of the tuning process can be increased. It is noted that a motor encoder generally refers to a rotary encoder mounted to an electric motor that provides closed loop feedback signals by tracking the speed and/or position of a motor shaft, and that a motor drive or drive generally refers to the equipment used to control speed of robot or machinery.

### System Overview

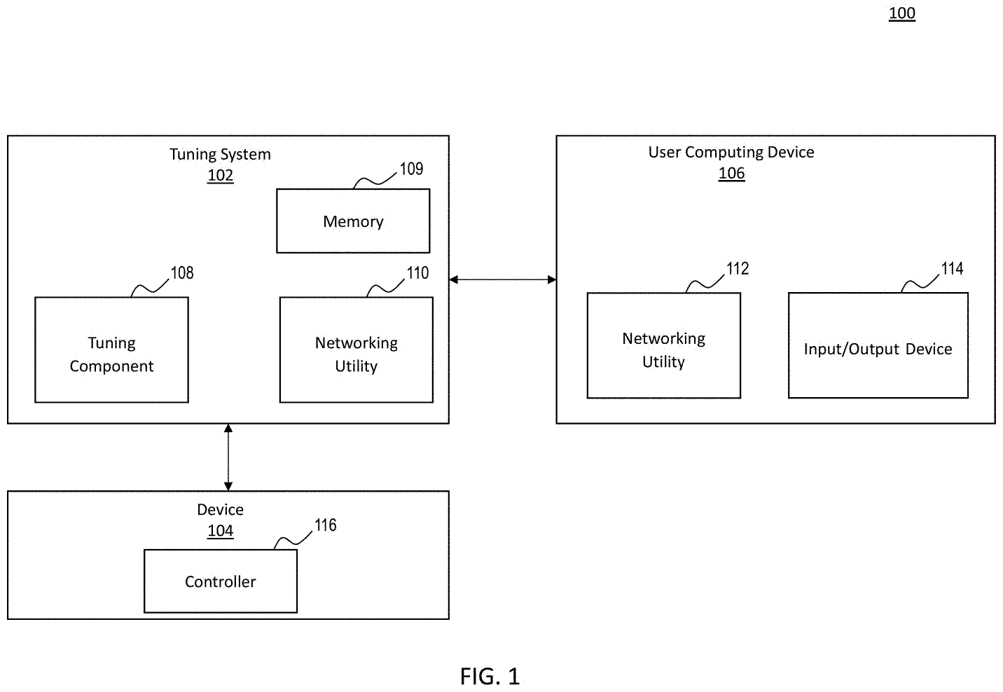

FIG. 1 depicts a schematic diagram of a system 100 including a tuning system 102 according to some embodiments herein. In the illustrated embodiment, the system 100 includes a tuning system 102, a device 104, and a user computing device 106. Any one or any combination of the components shown and described in FIG. 1 can each be implemented using one or more computing devices, such as, but not limited to one or more servers, processors, computing devices, virtual machines, etc., and can communicate via a wired connection or a wireless connection (e.g., via a network not shown in FIG. 1) for tuning of the device 104. For example, the tuning system 102 and the user computing device 106 may communicate via a local area network or a wide area network such as the Internet.

The tuning system 102 and/or the user computing device 106 may include one or more computing systems or computing devices that can include any network-equipped computing device, for example desktop computers, laptops, smartphones, tablets, and the like or any non-network-equipped computing device. In some embodiments, the tuning system 102 and the user computing device 106 can be incorporated into the same computing system (e.g., laptop or smartphone, etc.).

The user computing device 106 may include one or more computing devices associated with a user. The user may utilize the user computing device 106 to provide a test, parameters, and/or a request to initiate a tuning process, etc. to the tuning system 102. The user computing device 106 may include a networking utility 112 and an input/output device 114.

The tuning system 102 may include one or more computing devices for tuning the device 104. The tuning system 102 can include a tuning component 108, memory 109, and a networking utility 110. The tuning system may utilize the tuning component 108 to tune the device 104. The tuning system 102 can communicate with the device 104 via a wired or wireless connection.

The device 104 may include one or more devices (e.g., a motor, a machine, equipment, a computing device, an engine, a chip, or any other devices). The device 104 may include one or more tunable components. In some embodiments, the device 104 may be the tunable component. In the example of FIG. 1, the device 104 includes a controller 116. The controller 116 may be a mechanical, electro-mechanical, or electronic device that causes the performance of an operation based on receive input (e.g., the parameters and/or the test).

The tuning system 102 and/or the user computing device 106 may include a networking utility for data communication. For example, as shown in FIG. 1, the tuning system 102 includes a networking utility 110 and the user computing device 106 includes a networking utility 112. The networking utility 110 and the networking utility 112 may enable data communication between the tuning system 102 and the user computing device 106. Further, the networking utility 110 and the networking utility 112 may enable data communication between the tuning system 102 and the user computing device 106 over a network (e.g., the Internet). The network can include any appropriate network, including an intranet, the Internet, a cellular network, a local area network or any other such network or combination thereof. Protocols and components for communicating via the Internet or any of the other aforementioned types of communication networks are known to those skilled in the art of computer communications and thus, need not be described in more detail herein.

The tuning system 102 and the device 104 may communicate data via a streaming data connection (e.g., via a data stream). For example, the tuning system 102, via the tuning component 108, may communicate a test and/or test parameters to the device 104 (e.g., at each interval of a tuning process) via the data stream, and, in response to the test and/or the test parameters, the device 104 may communicate tuning results to the tuning system 102 via the data stream. The tuning system 102 and the user computing device 106 may communicate data via a streaming data connection (e.g., via a data stream). The results data can be sent from Random Access Memory (RAM) (or other volatile memory) of the device 104 to RAM (or other volatile memory) of the tuning system 102. In some implementations, the results data can be sent from the RAM (or other volatile memory) of the running system 102 to the RAM (or other volatile memory) of the user computing device 106. The results data can be transferred without compiling and saving the data into a file on non-volatile memory or a long-term storage device. This approach can enable the test results data to be transferred and presented more quickly, which can permit the user to make the next adjustment to the tuning values sooner and accelerate the tuning process. The test results can include substantial amounts of data, in some cases, and this data transfer approach can accelerate the iterative tuning process significantly. The parameters and/or test information can be sent from the RAM (or other volatile memory) of the user computing device 106 to the RAM (or other volatile memory) of the tuning system 102, and/or from the RAM (or other volatile memory) of the tuning system 102 to the RAM (or other volatile memory) of the device 104. In some embodiments, the tuning system 102 and user computing system 106 can be integrated into the same computer or program (e.g., so that one data transfer link is used). In some embodiments, the tuning system can be built into the device 104 (e.g., so that one data transfer link is used).

The user computing device 106 includes an input/output device 114 for obtaining input identifying a test and/or one or more parameters, and/or for providing output identifying tuning results (e.g., output obtained via the networking utility 112). For example, the input/output device 114 may include a display, a touchscreen, a keypad, a speaker, a microphone, or any other device to receive input and/or provide an output. Further, the input/output device 114 may be an application programming interface (“API”). The user computing device 106 may communicate with the input/output device 114 to receive the test and/or one or more parameters. Further, the user computing device 106 may communicate with the input/output device 114 to enable (e.g., cause) display of the tuning results. In some embodiments, the user computing device may communicate the tuning results separately or may provide a uniform resource identifier (“URI”) (e.g., a uniform resource locator (“URL”)) that enables a system to access the tuning results.

In some embodiments, the system can permit a user to incrementally adjust a digit for a value of a selected parameter. For example, the user input/output device 114 can have a first input element (e.g., up arrow) to increase the value of the digit by one. The user input/output device 114 can have a second input element (e.g., down arrow) to decrease the value of the digit by one. With the digit 8 selected in the value 64.852, the up arrow can change the value to 64.952, and the down arrow can change the value to 64.752. When the digit changes from 9 to 0, it can increase the adjacent digit of the higher order of magnitude. When the digit changes from 0 to 9, it can decrease the adjacent digit of the higher order of magnitude. Using the above example, pressing the up arrow once would change 64.852 to 64.952, and pressing the up arrow a second time would change the value to 65.052. Then pressing the down arrow would change the value from 65.052 to 64.952. Tapping the button once can change the value by one. Holding the button can change the value repeatedly until the button is released. The user input/output device 114 can have a third input element (e.g., left arrow) to change the selected digit to a higher order of magnitude, and a fourth input element (e.g., right arrow) to change the selected digit to a lower order of magnitude. Using the example above with the value 64.852, pressing the left arrow would change the selected digit from the 10ths place (8) to the one's place (4). Pressing the right arrow would change the selected digit from the 10ths place (8) to the 100ths place (5). This configuration can enable a user to quickly modify testing parameter values using a relatively small number of user input elements.

The user can provide an input command to the input/output device 114 of the user computing device 106 to initiate tuning. In response, the tuning system 102 can receive a request to initiate a tuning process from the user computing device 106 via the networking utility 112 and the networking utility 110. The tuning process may include multiple intervals and, at each interval, the tuning system may automatically (e.g., without reinitialization of the tuning process by a user computing device) provide a test and parameters to (e.g., perform a test using the parameters on) the device 104. The tuning system 102 can perform tests repeatedly without additional commands to initiate tuning. The tuning system 102 can perform the same test using the same parameters repeatedly until additional user input is provided. The tuning system 102 can perform the same type of test repeatedly with different parameters if user input is provided to change the parameters. In some embodiments, the tuning system 102 may define the time intervals of the tuning process based on user input obtained from the user computing device 106. In some embodiments, the duration of time for each interval of the tuning process can be based on an amount of time that it takes to perform the test on the device 104. The tuning system 102 may continuously provide testing and parameters to the device 104 at each interval until a request to stop the tuning process is obtained from the user computing device 106.

Based on receiving the request to initiate the tuning process, the tuning component 108 of the tuning system 102 can initiate the tuning process of the device 104. For example, the tuning component 108 can provide an initial test and initial parameters to the device 104. Based on initiation of the tuning process, the tuning component 108 can repeatedly (e.g., periodically and continuously) provide a test and parameters from the memory 109 to the device 104 (e.g., via the data stream).

The tuning system 102 can receive the test and/or one or more parameters (e.g., an initial test and parameters and/or updated tests and parameters) from the user computing device 106 via the networking utility 112 and the networking utility 110. Based on receiving the test and/or one or more parameters, the tuning system 102 can store the test and/or the one or more parameters in the memory 109. During each interval of the tuning process, the tuning system 102 can obtain a test and/or parameters from the memory 109 and can provide the test and/or the parameters to the device 104. In some embodiments, the tuning system 102 can perform the tests on the device 104. The memory 109 can have active parameters (e.g., stored in memory), and the active parameters can be used for the active test currently being performed. The memory 109 can have one or more pending parameters (e.g., stored in memory), which can be used for a subsequent testing iteration. When the current test is completed, the pending parameters can become the active parameters and a new test can begin. In some situations, the pending parameters can be the same as the active parameters, such as if the user has not provided any input for changing parameters. If the user provides input (e.g., via the user computing system 106) to change one or more parameters, the current test can continue to use the unchanged parameters (e.g., the active parameters), and the one or more changed parameters can be stored in memory as the pending parameters. If the user provides additional input for additional changes to the one or more parameters, the new parameter value(s) can overwrite, or otherwise replace, the prior value(s) in the pending parameters. In some implementations, the pending parameters that are stored can be the changes relative to the active parameters, rather than a full set of replacement parameters. Then the active parameters can be updated based on the changes in the pending parameters before starting each new iteration of testing, and the changes in the pending parameters can be cleared (e.g., until new changes for the parameters are received).

In response to initiation of the tuning process, the device 104 can provide the test and/or the parameters to the controller 116 upon receiving the test and/or the parameters from the tuning system 102 at each interval of the tuning process. The controller 116 may perform one or more operations using the test and/or the parameters and generate tuning results. The device 104 may provide the tuning results to the tuning system 102 (e.g., via the data stream).

In one example, the tuning system 102 may include a tuning application (e.g., a Tuning C App Program), a middleware application (a “Gather Program”), and a networking program (e.g., Netcat). Further, the user computing device 106 may include a software UI, and a networking program (e.g., Netcat).

The tuning application can execute each iteration of the tuning process, and the middleware application of the tuning tool can write the data relating to the result of the tuning iteration to an output data structure (e.g., stdout). The networking programs on the tuning system 102 and the user computing device 106 can create a data connection, which allows the data from the output data structure to be streamed to a system live, to be processed and displayed on the fly. The operating system (OS) on which the foregoing can be implemented may be, but not limited to, for example a Linux-based system or a Windows OS. Based on the OS environment (e.g., the networking program and the UI software program on the user computing device 106), the user computing device 106 may also include a program to enable data communication between the networking program and the UI software program (e.g., via Cygwin). The networking program can create a data connection between the tuning system 102 and the user computing device 106, and the tuning tool can stream the data to the user computing device 106 using this data connection. This architecture can enable streaming of the tuning results to enable the tuning iterations to run continuously while the tuning results are collected and displayed to a user on the user computing device 106. The user can change the parameters on the user computing device 106 via the UI software program while the tuning iterations are continuously run. The parameters and/or a test may be obtained by the device 104 at each new interval of the tuning process, and thus, the results displayed to the user on the user computing device 106 may be current for each interval according to the parameters. As previously discussed, the user computing device 106 may initiate the tuning process once with initial parameters and/or an initial test and parameters and a test may be periodically and automatically provided to the device at each subsequent interval of the tuning process. Therefore, the tuning process can continuously run while accepting user input for parameters on the fly and updating the parameters for each interval of the tuning process without stopping the tuning process.

### Process for Live Tuning a Device

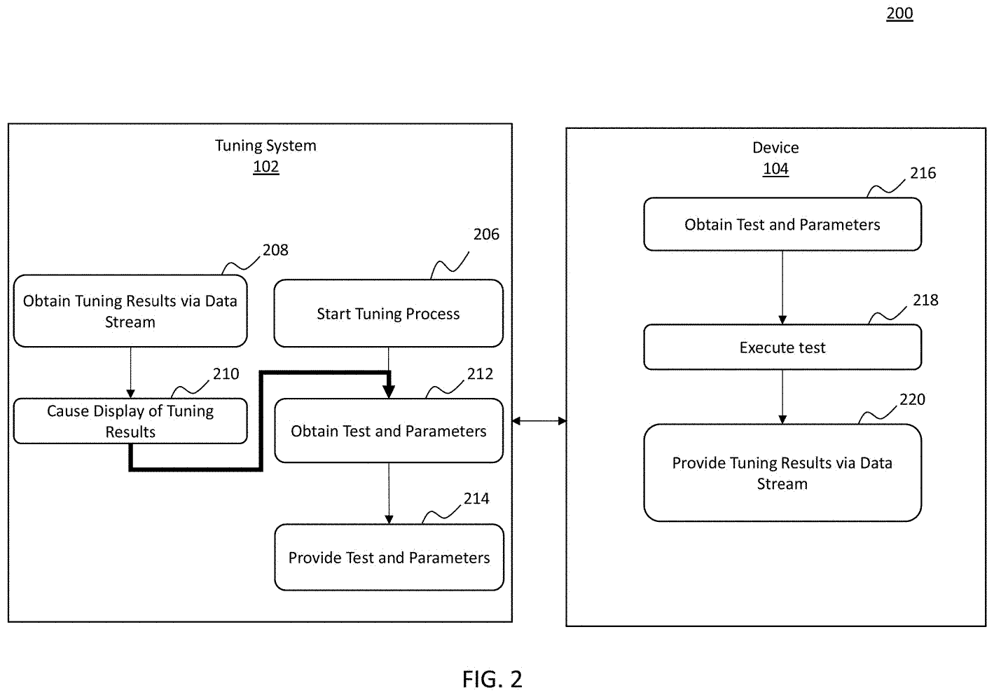

FIG. 2 illustrates an example configuration of a tuning environment 200 including a tuning system 102 for tuning the device 104 according to some embodiments. As discussed above, the tuning system 102 may include one or more tuning components for tuning the device 104 based on obtained input. Further, the tuning system 102 may include one or more networking utilities for communicating with the device 104 and/or a user computing device. The device 104 may include a controller that is provided the test and/or parameters and causes performance of an operation based on the test and/or parameters to generate tuning results. The device 104 can further provide the tuning results to the tuning system 102 to be provided to the user computing device.

In some embodiments, at 206, the tuning system 102 starts the tuning process. The tuning system 102 may start the tuning process in response to a request for initiation of the tuning process. For example, the tuning system 102 may obtain the request for initiation of the tuning process from a user computing device. Based on the obtaining the request for initiation of initiation of the tuning process, the tuning system 102 can identify a device 104 for tuning.

In some embodiments, the tuning system 102 may determine an interval for the tuning process (e.g., obtain from the user computing device, calculate, etc.). For example, the interval for the tuning process may be about 0.5 seconds, about 1 second, about 2 seconds, about 3 seconds, about 5 seconds, etc., or any values or ranges therebetween, although other suitable dime durations can be used. The interval may identify a time period for execution of a particular test. The tuning system 102 may calculate the interval based on the requested tuning process, a requested test, requested parameters, etc.

In some embodiments, at 212, the tuning system 102 obtains a test and/or parameters for an interval of the tuning process. The tuning system 102 may obtain the test and/or the parameters from memory of the tuning system 102. The tuning system 102 may obtain a test and parameters from a user computing device and store the test and parameters in the memory. The tuning system 102 may determine that an interval for the tuning process is satisfied such that a test and/or parameters should be provided to the device 104. In response to determining that the interval for the tuning process is satisfied, the tuning system 102 may obtain the test and/or the parameters from the memory. In some embodiments, a timer can be used to determine when the interval is satisfied to start the next testing iteration. In some embodiments, the next testing iteration can start in response to completion of the prior testing iteration.

In some embodiments, the tuning system 102 may obtain an initial test and/or initial parameters with the request to start the tuning process. For example, the tuning system 102 may obtain a request to start the tuning process, an initial test for the tuning process, and/or initial parameters for the tuning process from the user computing device.

In some embodiments, at 214, the tuning system 102 can provide the test and/or parameters to the device 104. For example, the tuning system 102 may provide the test and/or the parameters to the device 104 via a data stream. In some embodiments, the tuning system 102 may provide the test and the parameters separately to the device 104.

In some embodiments, at 216, the device obtains the test and/or the parameters. As previously discussed, the device can obtain the test and/or the parameters via a data stream with the tuning system 102.

In some embodiments, at 218, the device executes the test. For example, the device may execute the test by executing a move profile. The device may execute the test based on the parameters. Further, the device may execute the test in response obtaining the test and/or the parameters from the tuning system 102. In some embodiments, the device may execute the test by causing a controller of the device 104 to perform one or more operations based on the test and/or the parameters (e.g., execute a move profile).

In some embodiments, at 220, the device 104 provides tuning results to the tuning system 102 (e.g., via a data stream). The device 104 may obtain tuning results based on the execution of the test. The device 104 may monitor the execution of the test and determine tuning results based on monitoring the execution of the test. For example, the device 104 may track or monitor how a component performs an operation (e.g., how a controller causes movement based on the execution of the test) and generate tuning results that identify the performance of the operation. Based on determining the tuning results, the device can provide the tuning results to the tuning system 102, such as via a streaming data connection (e.g., a data stream) with the tuning system 102.

In some embodiments, at 208, the tuning system 102 obtains the tuning results from the device 104 via the data stream. The tuning system 102 may obtain the tuning results based on execution of the test according to the parameters by the device 104. Further, at 210, the tuning system 102 can cause display of the tuning results for the interval of the tuning process. For example, in response to obtaining the tuning results via the data stream, the tuning system 102 may provide the tuning results to a user computing device and cause display of the tuning results.

Blocks 212, 214, 216, 218, 220, 208, and 210 may be repeated for each interval of the tuning process. Further, the blocks may be repeated for any number of intervals. It will be understood that the tuning process may include any number of intervals. In some embodiments, the tuning process may continue until a request to stop the tuning process is obtained (e.g., from the user computing device). Therefore, subsequent to causing display of the tuning results, the tuning system 102 may obtain a test and parameters from the memory to provide to the device 104 for execution of the test. The user computing device may provide the test and/or the parameters to the memory of the tuning system 102. In some cases, the test and/or the parameters may be the same test and/or parameters as the test and/or parameters implemented during a prior interval of the tuning process (e.g., if the user computing device has not provided an updated test and/or parameters). In other cases, the test and/or the parameters may be different from the test and/or parameters implemented during the prior interval (e.g., if the user computing device did provide an updated test and/or updated parameters).

### User Interfaces for Displaying Live Tuning Results

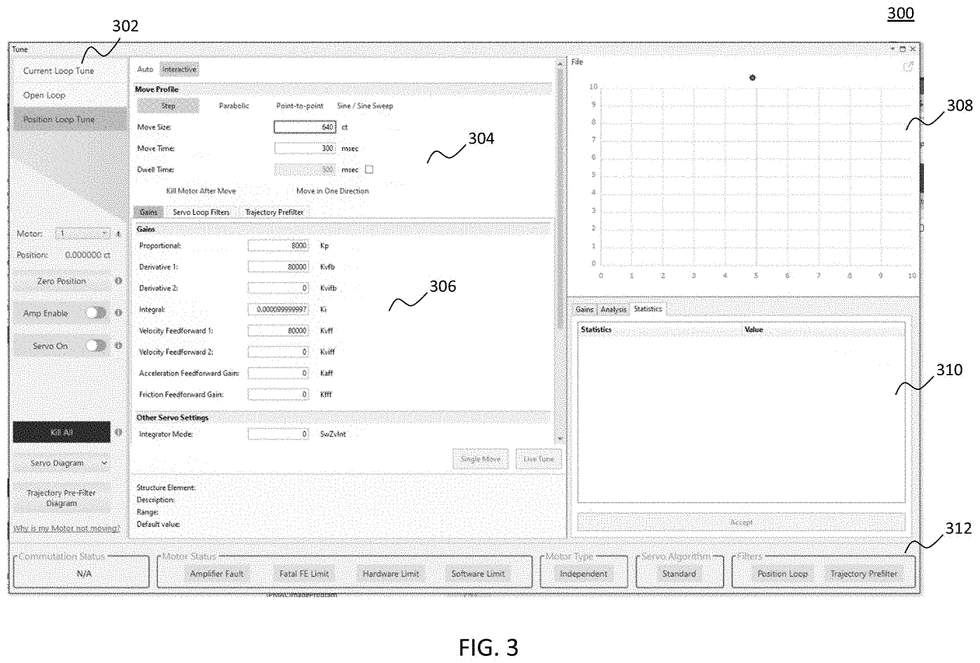

FIG. 3 depicts an example user interface 300 for obtaining a request for a tuning process for a device, a test, and/or parameters. The example user interface 300 is illustrative of an interface that the tuning system (or a separate system) can cause to be generated and presented to a user for tuning a device. It will be understood that the user interface 300 is illustrative only, and the tuning system may offer any type of user interface to enable tuning of the device.

The user interface 300 may further include a first interface 302, a second interface 304, a third interface 306, a fourth interface 308, a fifth interface 310, and a sixth interface 312. The user interface 300 may further include more, less, or different interfaces. The first interface 302 may be a tuning process selection interface, the second interface 304 may be an test selection interface, the third interface 306 may be a parameter selection interface, the fourth interface 308 may be a graphical tuning results interface, the fifth interface 310 may be a numerical tuning results interface, and the sixth interface 312 may be a settings interface.

Each of the first interface 302, the second interface 304, the third interface 306, the fourth interface 308, the fifth interface 310, and the sixth interface 312 may include multiple interfaces. For example, the first interface 302 may include multiple sub-interfaces. It will be understood that each interface may include more, less, or different interfaces. In some implementations, one or more of the interfaces 302, 304, 306, 308, 310, and 312 can be omitted, depending on the functionality of the system.

The first interface 302 may identify tuning process information. The tuning process information may identify one or more tuning processes (e.g., closed-loop tuning, open loop tuning, torque or current loop tuning, position or velocity loop tuning, etc.) that are available for selection. The one or more tuning processes may be based on the device that is selected for tuning and/or characteristics of the device. In the example of FIG. 3, the first interface 302 identifies the available tuning processes as “Current Loop Tune,” “Open Loop,” and “Position Loop Tune.” The first interface 302 further identifies the device is motor “1” and a position of the motor “0.000000 ct.” In some embodiments, the user interface can enable a user to define the units as counts (ct) per millimeter (or any other suitable unit of distance or position can be used, such as microns). In one example, the system can use 32,767 counts per millimeter, and the system can enable the user to specify various other count values, such as depending on the configuration of the device being tuned. Further, the first interface 302 includes one or more interactive elements to enable a user to zero a position of the device, enable an amplitude, turn the motor on and/or off, etc. It will be understood that the first interface 302 may identify more, less, or different information.

The second interface 304 may identify test information. The test information may identify one or more characteristics of each test (e.g., an interval of the test, a size of the test, etc.) that are available for selection and modification and each test that is available for selection. The one or more characteristics may be based on the particular test that is selected. In the example of FIG. 3, the second interface 304 identifies the available tests as “Step,” “Parabolic,” “Point-to-point,” and “Sine/Sine Sweep.” For the “Step” test, the second interface 304 identifies the available characteristics for modification as “Move Size” with a value of “640 ct,” “Move Time” with a value of “300 milliseconds,” and “Dwell Time” with a value of “500 milliseconds.” It will be understood that the second interface 304 may identify more, less, or different information.

The third interface 306 may identify parameter information. The parameter information may identify one or more parameters that are available for selection and modification (e.g., during live tuning). The third interface 306 may identify one or more groups of parameters for selection and modification. In the example of FIG. 3, the third interface 306 identifies the groups of parameters as “Gains,” “Servo Loop Filters,” and “Trajectory Prefilter.” For the “Gains” group of parameters, the third interface 306 identifies the available parameters for modification as “Proportional Gain” (Kp) with a value of “8000,” “Derivative Gain 1” (Kvfb) with a value of “80000,” “Derivative Gain 2” (Kvifb) with a value of “0,” “Integral Gain” (Ki) with a value of “0.000099999997,” “Velocity Feedforward Gain 1” (Kvff) with a value of “80000,” “Velocity Feedforward Gain 2” (Kviff) with a value of “0,” “Acceleration Feedforward Gain” (Kaff) with a value of “0,” “Friction Feedforward Gain” (Kfff) with a value of “0,” and “Integrator Mode” (SwZvInt) with a value of “0.” In some embodiments, an Integrator Mode value of “1” can indicate that position error integration is performed only when the motor is not commanding a move, and an Integrator Mode value of “0” can indicate that position error integration is performed or at any time regardless of whether the motor is commanding a move. It will be understood that the third interface 306 may identify more, less, or different information.

The fourth interface 308 may identify tuning results in a graphical format. Based on receiving tuning results from a device, the tuning system may cause display of the tuning results in a graphical format in the fourth interface 308. The fifth interface 310 may identify tuning results in a non-graphical (e.g., a numerical, alphabetical, alphanumerical, symbolical, etc.) format. Based on receiving tuning results from a device, the tuning system may cause display of the tuning results in a non-graphical format in the fifth interface 310. It will be understood that the fourth interface 308 and the fifth interface 310 may identify more, less, or different information.

The sixth interface 312 may identify settings and/or status information. The setting may identify one or more adjustable settings or status identifiers (e.g., filters, limits, device statuses, device types, device algorithms, etc.), such as to adjust or report on how the test is implemented by the device and/or how the tuning results are generated, determined, or displayed. In the example of FIG. 3, the sixth interface 312 identifies the settings as “Trajectory Prefilter,” “Position Loop,” “Standard Servo Algorithm,” “Independent Motor Type,” “Amplifier Fault,” “Fatal FE limit,” “Hardware Limit,” or “Software Limit.” It will be understood that the sixth interface 312 may identify more, less, or different information.

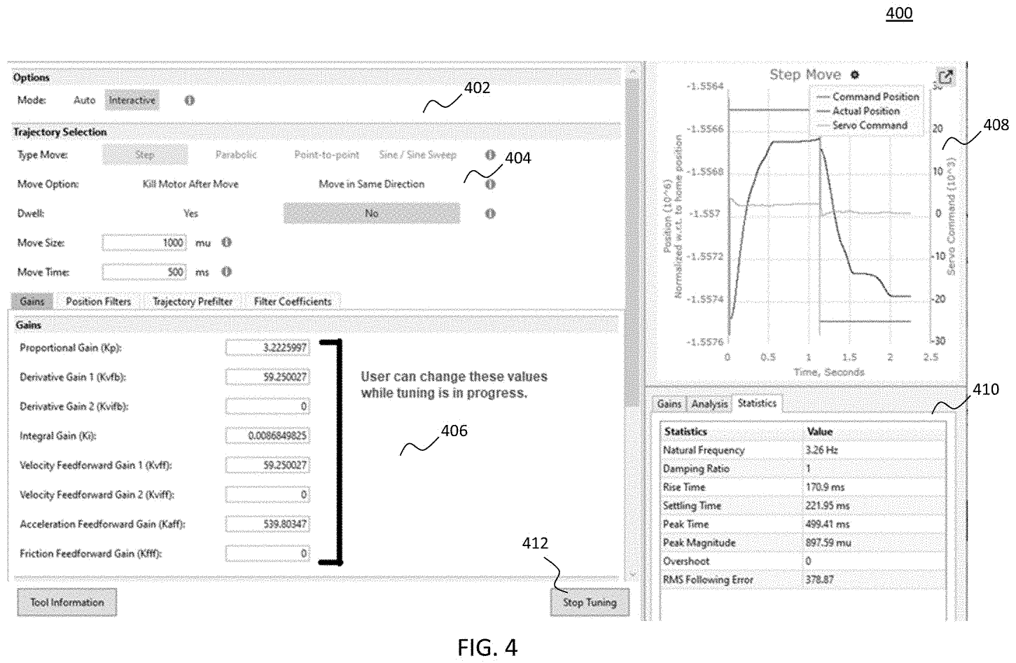

FIG. 4 depicts an example user interface 400 for obtaining a request a tuning process for a device, a test, and/or parameters and displaying tuning results. The example user interface 400 is illustrative of an interface that the tuning system (or a separate system) can cause to be generated and presented to a user for tuning a device and display tuning results. It will be understood that the user interface 400 is illustrative only, and the tuning system may offer any type of user interface to enable tuning of the device.

The user interface 400 may further include a first interface 402, a second interface 404, a third interface 406, a fourth interface 408, a fifth interface 410, and a sixth interface 412. The user interface 400 may further include more, less, or different interfaces. The first interface 402 may be a tuning method interface, the second interface 404 may be an test selection interface, the third interface 406 may be a parameter selection interface, the fourth interface 408 may be a graphical tuning results interface, the fifth interface 410 may be a numerical tuning results interface, and the sixth interface 412 may be a tuning initiation interface.

Each of the first interface 402, the second interface 404, the third interface 406, the fourth interface 408, the fifth interface 410, and the sixth interface 412 may include multiple interfaces. For example, the first interface 402 may include multiple sub-interfaces. It will be understood that each interface may include more, less, or different interfaces.

The first interface 402 may identify tuning method information. The tuning method information may identify one or more methods of tuning a device (e.g., auto tuning, interactive or live tuning, etc.) that are available for selection. The one or more methods of tuning may be based on the device that is selected for tuning and/or characteristics of the device. In the example of FIG. 4, the first interface 402 identifies the available tuning methods as “Auto” and “Interactive.” It will be understood that the first interface 402 may identify more, less, or different information.

The second interface 404 may identify test information. As discussed above, the test information may identify one or more characteristics of each test that are available for selection and modification and each test that is available for selection. In the example of FIG. 4, the second interface 404 identifies the available tests as “Step,” “Parabolic,” “Point-to-point,” and “Sine/Sine Sweep.” For the “Step” test, the second interface 404 identifies the available characteristics for modification as “Move Size” with a value of “1000 mu,” “Move Time” with a value of “500 milliseconds,” and “Dwell” with a value of “No.” The second interface 404 also include parameters for selecting the device to move in a particular direction and/or stopping (e.g., killing) the device after a test. It will be understood that the second interface 404 may identify more, less, or different information. “Move Size” can be the distance that the motor will first travel in the positive direction before reversing and traveling the same distance in the opposite direction. The units can be motor units (mu), which can be defined by the user similar to counts (cn) discussed above, although any suitable units of distance can be used. “Move Time” can be the time span within which the motor will traverse the distance specified in “Move Size” in the positive direction, and then that same distance in the opposite direction within the “Move Time” time span again.

The third interface 406 may identify parameter information. As discussed above, the parameter information may identify one or more parameters that are available for selection and modification (e.g., during live tuning). The third interface 406 and/or the second interface 404 may enable users to change parameters and/or tests for implementation in a next interval of the tuning process. In some implementations, one or more or all the parameters of the third interface 406 can be adjustable on the fly during live tuning, whereas one or more or all of the parameters of the second interface 404 can be set for the duration of the tuning session. In the example of FIG. 4, the third interface 406 identifies the groups of parameters as “Gains,” “Position Filters,” “Trajectory Prefilter,” and “Filter Coefficients.” For the “Gains” group of parameters, the third interface 406 identifies the available parameters for modification as “Proportional Gain” (Kp) with a value of “3.2225997,” “Derivative Gain 1” (Kvfb) with a value of “59.250027,” “Derivative Gain 2” (Kvifb) with a value of “0,” “Integral Gain” (Ki) with a value of “0.0086849825,” “Velocity Feedforward Gain 1” (Kvff) with a value of “59.250027,” “Velocity Feedforward Gain 2” (Kviff) with a value of “0,” “Acceleration Feedforward Gain” (Kaff) with a value of “539.80347,” and “Friction Feedforward Gain” (Kfff) with a value of “0.” It will be understood that the third interface 406 may identify more, less, or different information. Various other values and parameters can be used.

The fourth interface 408 may identify tuning results in a graphical format and the fifth interface 410 may identify tuning results in a non-graphical (e.g., a numerical, alphabetical, alphanumerical, symbolical, etc.) format. The fourth interface 408 may include a graphical display of the tuning results streamed to the user computing device from the tuning system, as described herein with respect to FIG. 1. The fifth interface 410 may include a section for a non-graphical display (e.g., a statistical based display) of the tuning results. The fourth interface 408 and the fifth interface 410 can be continuously updated based on the tuning results streamed from the tuning system to the user computing device. Further, the fourth interface 408 and the fifth interface 410 can reflect updates to the test and/or parameters provided by the user, via the user computing device, and applied to the tuning process on the fly. It will be understood that the fourth interface 408 and the fifth interface 410 may identify more, less, or different information. In some embodiments, the user interface can include an indicator of what values for the parameters were used to generate the test results currently displayed. The user interface can include an icon or other indicator that shows which values have been changed from the values that generated the currently displayed results. In some embodiments, a clock, hourglass, spinning circle, or other indicator can be positioned next to the values that have been changed since the test that produced the displayed results. In some embodiments, the user interface can display both the values that produced the displayed results as well as the current or pending values for testing not yet completed (e.g., as separate columns).

The sixth interface 412 may identify tuning initiation information. For example, the sixth interface 412 can include a selectable element(s) to start and/or stop the tuning process. In the example of FIG. 4, the sixth interface 412 includes a “Stop Tuning” element which may be selectable when the tuning process is in progress. It will be understood that the sixth interface 412 may identify more, less, or different information.

### Live Tuning a Device

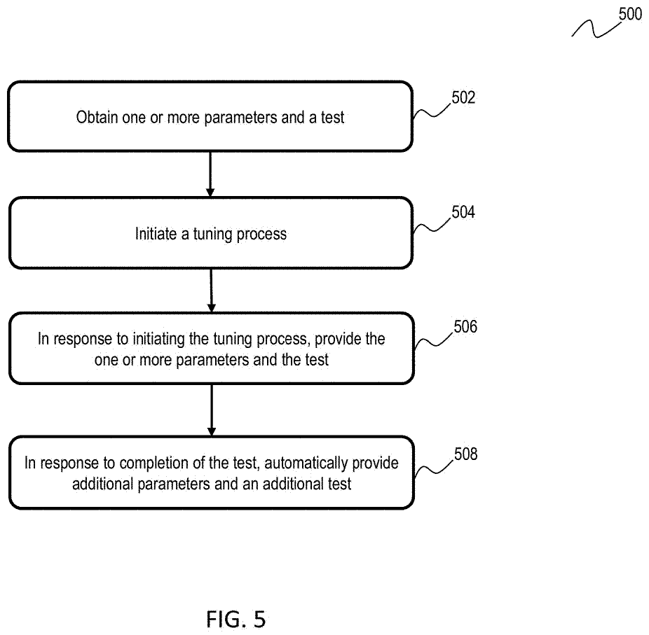

FIG. 5 shows a method 500 executed by a tuning system utilizing a continuous (e.g., live, interactive, etc.) tuning process for tuning a device (e.g., a servo motor), according to some examples of the disclosed technologies. The tuning system may be similar, for example, to the tuning system 102 as discussed above, and may include a tuning component similar to tuning component 108, memory similar to memory 109, and/or a networking utility similar to networking utility 110.

At block 502, the tuning system obtains one or more parameters and/or a test. The one or more parameters and/or the test may identify a device for execution of the test according to the parameters. The tuning system may obtain the one or more parameters and/or the test from a user computing device (e.g., via a user interface of the user computing device). In some embodiments, the tuning system may obtain the one or more parameters and the test from a memory of the tuning system. The test may include a step test, a ramp test, a parabolic velocity test, a trapezoidal velocity test, an s-curve velocity test, a sinusoidal test, a sinesweep test, and/or a user-defined test, etc. Further, the test may define and/or include a move size, a move speed, and/or a move profile, etc. The parameters may include a proportional gain, a derivative gain, a velocity feedforward gain, an integral gain, an integration mode, an acceleration feedforward gain, and/or a friction feedforward gain, etc. In some embodiments, the parameters may include hardware parameters. For example, the parameters may be based on hardware components of the device, a connection between the device and the system, and/or a connection between the device and another component.

At block 504, the tuning system initiates a tuning process. The tuning system may initiate the tuning process based on the one or more parameters and the test. The tuning system may receive user input via a user interface (e.g., identifying a request to initiate a tuning process) and may initiate the tuning process in response to the user input. The tuning system may further identify a tuning schedule for the tuning process. The tuning schedule may identify one or more intervals for providing parameters and/or a test to the device.

At block 506, the tuning system, in response to initiating the tuning process, provides the one or more parameters and/or the test to the device. For example, the tuning system may provide the one or more parameters and the test based on the tuning schedule. Based on providing the one or more parameters and the test to the device, the tuning system may obtain tuning results from the device. For example, the device can generate the tuning results based on the one or more parameters and the test and provide the tuning results to the tuning system. The tuning system can obtain the tuning results via a data stream from the device. The tuning system may cause display of at least a portion of the tuning results via a display of a user interface (e.g., a user interface of a user computing device). Further, the tuning system may cause display of the one or more parameters, the test, and/or the at least a portion of the tuning results.

At block 508, the tuning system, in response to completion of the test, automatically provides additional parameters and an additional test to the device. The tuning system may provide the additional parameters and the additional test to the device subsequent to providing the one or more parameters and the test to the device. For example, the tuning system may provide the additional parameters and the additional test based on the tuning schedule. Further, the tuning system may automatically provide the additional parameters and the additional test to the device without reinitiating the tuning process, without receiving user input via the user interface after initiation of the tuning process, and/or without receiving user input other than user input defining parameters and/or a test.

To provide the additional parameters and the additional test, the tuning system may obtain the additional parameters and the additional test from a user computing device and store the additional parameters and the additional test in the memory. As subsequent parameters and/or tests are obtained, the tuning system may replace the parameters and/or tests with the updated parameters and/or tests such that the parameters and/or test received last are provided in the next interval of the tuning process. To provide the additional parameters and the additional test to the device, the tuning system may obtain the additional parameters and the additional test from the memory. In some embodiments, the tuning system may not obtain additional parameters and/or the additional test from a user computing device prior to a next interval of the tuning process. Specifically, tuning system may obtain the one or more parameters and/or the test from the memory (e.g., because the one or more parameters and/or the test may not be replaced with updated parameters and/or an updated test) and provide the one or more parameters and/or the test to the device. Therefore, the one or more parameters may be the same or different parameters from the additional parameters and the test may be the same or a different test from the additional test.

In some embodiments, the tuning system may determine whether user input (e.g., defining a parameter and/or a test) has been obtained prior to automatically providing the additional test and/or the additional parameters to the device. If the tuning system determines that user input has not been obtained, the tuning system may provide the one or more parameters and/or the test to the device. If no user input was provided to change any parameters, the device may use the same parameters and/or test for the next test iteration. If the tuning system determines that user input has been obtained, the tuning system may provide the user input (or the new test and/or parameter(s) indicated by the user input) to the device. In some embodiments, the tuning system may obtain an updated set of parameters but not an updated test (or an updated test but not an updated set of parameters) and the tuning system may provide the updated set of parameters with the test (e.g., the test obtained at block 502) to the device.

Based on automatically providing the additional parameters and the additional test to the device, the tuning system may obtain additional tuning results from the device. The tuning system may cause display of at least a portion of the additional tuning results via the display of the user interface.

The tuning system may continuously (e.g., automatically and periodically) provide parameters and a test to the device at each interval of the tuning process (e.g., based on the tuning schedule). For example, the tuning system may provide the parameters and/or the test at each interval until a request to discontinue the tuning process is obtained (e.g., from a particular user computing device). For example, the tuning system may obtain user input, determine that the tuning process has been discontinued based on the user input, and stop tuning the device.

The tuning systems disclosed herein can enable repeat test profiles to be executed with only a single start input from user, and the test profiles can continue to repeat until the user provides a stop input. For each of the test iterations, the tuning systems disclosed herein can collect, transmits, parse, and/or display the data of the test results. The tuning system can perform post processing of data such as Fast Fourier Transform (FFT) and derivative calculations. The tuning systems can display data including graphs, statistical data, and/or active gain parameters from the most recent test iteration. During the tests, a user can change test parameters and gains and observe the results during or after the next test iteration. The tuning systems disclosed herein can be used for studying the effects of external factors on motor response or other tested device features. By reducing the user workload, the tuning systems disclosed herein can significantly reduce tuning time. The tuning systems disclosed herein can be used to establish constancy of response between multiple testing iterations. The Appendix to the U.S. Provisional Application No. 63/191,882, which is incorporated herein by reference includes additional information regarding the tuning systems.

Conditional language, such as “can,” “could,” “might,” or “may,” unless specifically stated otherwise, or otherwise understood within the context as used, is generally intended to convey that certain examples include or do not include, certain features, elements, and/or steps. Thus, such conditional language is not generally intended to imply that features, elements, and/or steps are in any way required for one or more examples.

Several illustrative examples of live tuning of a motor have been disclosed. Although this disclosure has been described in terms of certain illustrative examples and uses, other examples and other uses, including examples and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various examples. All possible combinations and subcombinations of elements and components described herein are intended to be included in this disclosure. No single feature or group of features is necessary or indispensable.

Certain features that are described in this disclosure in the context of separate implementations can also be implemented in combination in a single implementation. Conversely, various features that are described in the context of a single implementation also can be implemented in multiple implementations separately or in any suitable subcombination. Moreover, although features may be described above as acting in certain combinations, one or more features from a claimed combination can in some cases be excised from the combination, and the combination may be claimed as a subcombination or variation of a subcombination.

Any portion of any of the steps, processes, structures, and/or devices disclosed or illustrated in one example in this disclosure can be combined or used with (or instead of) any other portion of any of the steps, processes, structures, and/or devices disclosed or illustrated in a different example or flowchart. The examples described herein are not intended to be discrete and separate from each other. Combinations, variations, and some implementations of the disclosed features are within the scope of this disclosure.

While operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Additionally, the operations may be rearranged or reordered in some implementations. Also, the separation of various components in the implementations described above should not be understood as requiring such separation in all implementations, and it should be understood that the described components and systems can generally be integrated together in a single product or packaged into multiple products. Additionally, some implementations are within the scope of this disclosure.

Further, while illustrative examples have been described, any examples having equivalent elements, modifications, omissions, and/or combinations are also within the scope of this disclosure. Moreover, although certain aspects, advantages, and novel features are described herein, not necessarily all such advantages may be achieved in accordance with any particular example. For example, some examples within the scope of this disclosure achieve one advantage, or a group of advantages, as taught herein without necessarily achieving other advantages taught or suggested herein. Further, some examples may achieve different advantages than those taught or suggested herein.

Some examples have been described in connection with the accompanying drawings. The figures are drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various examples can be used in all other examples set forth herein. Additionally, any methods described herein may be practiced using any device suitable for performing the recited steps.

For purposes of summarizing the disclosure, certain aspects, advantages and features of the inventions have been described herein. Not all, or any such advantages are necessarily achieved in accordance with any particular example of the inventions disclosed herein. No aspects of this disclosure are essential or indispensable. In many examples, the devices, systems, and methods may be configured differently than illustrated in the figures or description herein. For example, various functionalities provided by the illustrated modules can be combined, rearranged, added, or deleted. In some implementations, additional or different processors or modules may perform some or all of the functionalities described with reference to the examples described and illustrated in the figures. Many implementation variations are possible. Any of the features, structures, steps, or processes disclosed in this specification can be included in any example.

In some embodiments, the methods, techniques, microprocessors, and/or controllers described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. The instructions can reside in RAM memory, flash memory, ROM memory, EPROM memory, EEPROM memory, registers, hard disk, a removable disk, a CD-ROM, or any other form of a non-transitory computer-readable storage medium. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

The microprocessors or controllers described herein can be coordinated by operating system software, such as iOS, Android, Chrome OS, Windows, Unix, Linux, SunOS, Solaris, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

The microprocessors and/or controllers described herein may implement the techniques described herein using customized hard-wired logic, one or more ASICs or FPGAs, firmware and/or program logic which causes microprocessors and/or controllers to be a special-purpose machine. According to one embodiment, parts of the techniques disclosed herein are performed a controller in response to executing one or more sequences instructions contained in a memory. Such instructions may be read into the memory from another storage medium, such as storage device. Execution of the sequences of instructions contained in the memory causes the processor or controller to perform the process steps described herein. In alternative embodiments, hard-wired circuitry may be used in place of or in combination with software instructions.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the techniques described herein may be implemented in analog circuitry or mixed analog and digital circuitry.

In summary, various examples of live tuning of a motor have been disclosed. This disclosure extends beyond the specifically disclosed examples to other alternative examples and/or other uses of the examples, as well as to certain modifications and equivalents thereof. Moreover, this disclosure expressly contemplates that various features and aspects of the disclosed examples can be combined with, or substituted for, one another. Accordingly, the scope of this disclosure should not be limited by the particular disclosed examples described above.

1. A system for tuning a device, the system comprising:
a user interface;
at least one processor;
a memory storing computer-executable instructions, wherein execution of the computer-executable instructions by the at least one processor causes the at least one processor to:
obtain one or more first parameters;
identify a first test;
initiate a tuning process of the device based on the first test and the one or more first parameters;
in response to initiating the tuning process:
provide the first test and the one or more first parameters to the device;
obtain, from the device, tuning results based on providing the first test and the one or more first parameters to the device;
cause display of at least a portion of the tuning results via a display of the user interface; and
automatically provide a second test and/or one or more second parameters to the device subsequent to providing the first test and the one or more first parameters to the device.

2. The system of claim 1, wherein execution of the computer-executable instructions by the at least one processor further causes the at least one processor to:
obtain additional tuning results based on providing the second test and/or the one or more second parameters to the device, and
cause display of at least a portion of the additional tuning results via the display of the user interface.

3.-6. (canceled)

7. The system of claim 1, wherein the first test comprises at least one of:
a step test;
a ramp test;
a parabolic velocity test;
a trapezoidal velocity test;
an s-curve velocity test;
a sinusoidal test;
a sinesweep test; or
a user-defined test.

8. The system of claim 1, wherein the first test comprises a move size, a move speed, and a move profile.

9. The system of claim 1, wherein the one or more first parameters comprise at least one of:
a proportional gain;
a derivative gain;
a velocity feedforward gain;
an integral gain;
an acceleration feedforward gain; or
a friction feedforward gain.

10. The system of claim 1, wherein the one or more first parameters comprise one or more hardware parameters, wherein the one or more hardware parameters are based on at least one of one or more hardware components of the device, a connection between the device and the system, or a connection between the device and a component.

11. The system of claim 1, wherein to provide the second test and/or the one or more second parameters, execution of the computer-executable instructions by the at least one processor further causes the at least one processor to automatically provide the second test and/or the one or more second parameters to the device without reinitiating the tuning process.

12. The system of claim 1, wherein execution of the computer-executable instructions by the at least one processor further causes the at least one processor to obtain the one or more first parameters via the user interface.

13. The system of claim 1, wherein execution of the computer-executable instructions by the at least one processor further causes the at least one processor to:
receive user input via the user interface; and
initiate the tuning process based on the user input.

14. (canceled)

15. The system of claim 1, wherein execution of the computer-executable instructions by the at least one processor further causes the at least one processor to obtain the tuning results via a data stream from the device.

16.-19. (canceled)

20. The system of claim 1, wherein the device is a servo motor.

21. The system of claim 1, wherein execution of the computer-executable instructions by the at least one processor further causes the at least one processor to obtain the one or more second parameters from a memory.

22. The system of claim 21, wherein execution of the computer-executable instructions by the at least one processor further causes the at least one processor to:
store the one or more first parameters in the memory;
obtain the one or more second parameters; and
replace the one or more first parameters with the one or more second parameters in the memory based on obtaining the one or more second parameters.

23. The system of claim 1, wherein execution of the computer-executable instructions by the at least one processor further causes the at least one processor to cause display of:
the one or more first parameters;
data associated with the first test; and
the at least a portion of the tuning results.

24. The system of claim 1, wherein execution of the computer-executable instructions by the at least one processor further causes the at least one processor to, in response to initiating the tuning process, periodically provide a corresponding test and one or more corresponding parameters to the device.

25. The system of claim 24, wherein execution of the computer-executable instructions by the at least one processor further causes the at least one processor to:
determine that the tuning process has been discontinued, and
discontinue periodically providing the corresponding test and the one or more corresponding parameters to the device based on determining that the tuning process has been discontinued.

26.-28. (canceled)

29. A non-transitory computer readable storage medium having stored thereon instructions that, when executed, cause at least one computing device to:
obtain one or more parameters;
identify a test;
initiate a tuning process of the device based on the test and the one or more parameters;
in response to initiating the tuning process, periodically:
perform the test using the one or more parameters on the device;
obtain, from the device, tuning results based on providing the test and the one or more parameters to the device; and
cause display of at least a portion of the tuning results via a display of a user interface.

30. A method for tuning a device, the method comprising:
obtaining one or more parameters;
identifying a test;
initiating a tuning process of the device based on the test and the one or more parameters;
in response to initiating the tuning process, periodically:
performing the test using the one or more parameters on the device;
obtaining, from the device, tuning results based on providing the test and the one or more parameters to the device; and
causing display of at least a portion of the tuning results via a display of a user interface.

31. A method for tuning a device, the method comprising:
obtaining one or more first parameters;
performing a first test on the device using the one or more first parameters;
outputting test results from the first test;
obtaining one or more second parameters different from the one or more first parameters during performance of the first test;
storing the one or more second parameters while the first test finishes using the one or more first parameters;
after completion of the first test, automatically performing a second test on the device using the one or more second parameters; and
outputting the results from the second test.

32.-39. (canceled)

40. A non-transitory computer readable storage medium having stored thereon instructions that, when executed, cause at least one computing device to perform the method of claim 31.
